(19) United States
(12) Patent Application Publication
(10) Pub. No.: US 2008/0224041 A1
(43) Pub. Date: Sep. 18, 2008

(54) METHOD AND APPARATUS FOR SUBSURFACE ANOMALY DETECTION AND IMAGE PROJECTION

(76) Inventor: John J. Cannamela, Waxhaw, NC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 11/687,022

(22) Filed: Mar. 16, 2007

(51) Int. Cl. G01N 21/84

(52) U.S. Cl. 250/330; 374/124

(57) ABSTRACT

A method of detecting subsurface anomalies that includes the steps of utilizing a detector to determine the existence of a subsurface anomaly at a location behind the surface, and generating a signal representative of the anomaly. The signal is transmitted to a projector mounted in image alignment with the detector. The signal is converted into a visual representation of the anomaly; and the visual representation of the anomaly is projected onto the surface at the location on the surface behind which the subsurface anomaly is present. An apparatus for carrying out the method is also disclosed.

### TECHNICAL FIELD AND BACKGROUND OF THE INVENTION

This invention relates to a method and apparatus for subsurface anomaly detection and image projection. In particular, the invention relates to a method and apparatus for utilizing, for example, a thermal infrared camera to detect anomalies behind floors, walls, ceilings and in machinery that may be indicative of subsurface conditions such as moisture, overheated areas, malfunctioning machine parts, missing insulation or seals, wall voids, pests and similar other conditions.

Thermal infrared (IR) imaging cameras and similar detectors are known. Typical uses involve detecting the conditions such as set out above. Ordinarily, such cameras store digital data representing any such anomalies in, for example, a PCMCIA card or other memory devices. The images can then be analyzed by computer using software available for this purpose, and reports generated that may include pictures or graphs indicating the general location of the anomaly. Some cameras have small, low resolution viewfinders.

This practice presents several problems. First, the small viewfinders do not permit precise aiming of the camera, particularly in high ambient light conditions. Second, it is often not possible to locate the exact location of the anomaly, particularly if the surface being examined is large and relatively featureless. Third, the detection may be of a transient anomaly. If this is the case it may be difficult to confirm the location of the anomaly later, after having received a report of the results. Finally, in situations where damage is occurring or may be prevented by prompt action, downloading and analyzing data for preparation of a report may result in damage that could otherwise have been avoided by a more rapid response.

For these reasons, there exists a need for an apparatus and method for rapidly and accurately detecting subsurface anomalies.

### SUMMARY OF THE INVENTION

Therefore, it is an object of the invention to provide an apparatus and method for rapidly and accurately detecting subsurface anomalies.

These and other objects and advantages of the invention are achieved by providing an apparatus for detecting subsurface anomalies, comprising a detector for determining the existence of a subsurface anomaly at a location behind a surface and generating a signal representative of the anomaly, and a projector mounted in image alignment with the detector for receiving the signal, converting the signal into a visual representation of the anomaly and projecting the visual representation of the anomaly onto the surface at the location on the surface behind which the subsurface anomaly is present.

According to one preferred embodiment of the invention, the detector comprises an infrared detector.

According to another preferred embodiment of the invention, the detector comprises a thermal infrared camera capable of temperature measurement.

According to another preferred embodiment of the invention the detector comprises a thermal infrared camera capable of temperature measurement, and including a data store for storing digital data representative of temperature measurement.

According to another preferred embodiment of the invention, the projector comprises a video projector.

According to another preferred embodiment of the invention, the projector comprises a DLP projector.

According to another preferred embodiment of the invention, the detector and projector are separate devices connected by a data transfer cable.

According to another preferred embodiment of the invention, an apparatus for detecting subsurface anomalies is provided, and comprises an infrared camera for determining the existence of a subsurface anomaly detectable by the infrared camera at a location behind a surface and generating a signal representative of the anomaly; and a projector mounted in image alignment with the detector for receiving the signal, converting the signal into a visual representation of the anomaly and projecting the visual representation of the anomaly onto the surface in alignment with the subsurface anomaly.

According to another preferred embodiment of the invention, the camera and projector are mounted on a common mounting device.

According to another preferred embodiment of the invention, the camera and projector are mounted in vertically spaced-apart relation to each other, and are parallax-corrected for projecting the visual representation of the anomaly at the precise location on the surface behind which the anomaly is present.

According to a preferred embodiment of the method of detecting subsurface anomalies according to the invention, the method includes the steps of providing a detector for determining the existence of a subsurface anomaly at a location behind a surface, utilizing the detector to determine the existence of a subsurface anomaly at a location behind the surface, and generating a signal representative of the anomaly. The signal is transmitted to a projector mounted in image alignment with the detector. The signal is converted into a visual representation of the anomaly; and the visual representation of the anomaly is projected onto the surface at the location on the surface behind which the subsurface anomaly is present.

According to another preferred embodiment of the invention, the step of providing a detector comprises providing an infrared detector.

According to another preferred embodiment of the invention, the step of providing a detector comprises providing a thermal infrared camera capable of temperature measurement.

According to another preferred embodiment of the invention, the method includes the step of storing digital data representative of temperature measurement.

According to another preferred embodiment of the invention, the step of providing the projector comprises providing a video projector, which may be a DLP projector.

According to another preferred embodiment of the invention, the method includes positioning the detector and projector in spaced-apart relation to each other and correcting any parallax between the detector and projector.

According to another preferred embodiment of the invention, the method includes projecting the visual representation of the anomaly onto the surface at the location on the surface behind which the subsurface anomaly is present simultaneously with detecting the anomaly.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a perspective view of an apparatus for detecting subsurface anomalies and projecting a visual image of the anomaly; and

FIG. 2 is a perspective view illustrating detection of a subsurface anomaly and projecting the anomaly onto the surface being examined.

### DESCRIPTION OF THE PREFERRED EMBODIMENTS AND BEST MODE

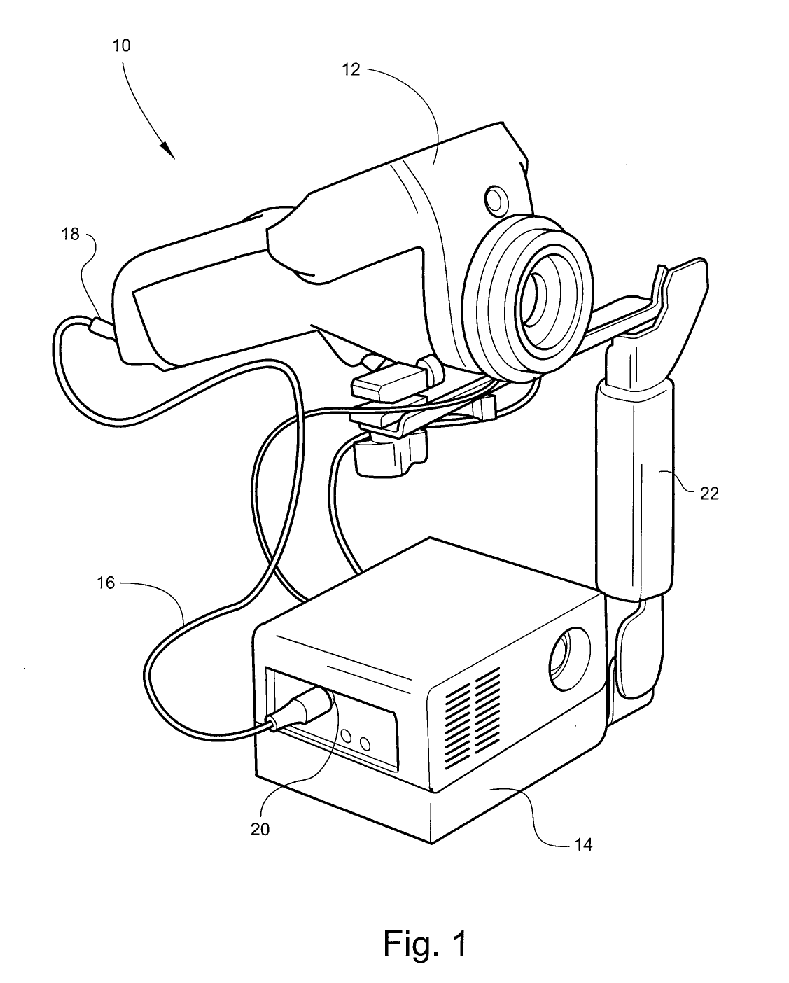

Referring now specifically to the drawings, an apparatus for detecting subsurface anomalies according to the present invention is shown generally in FIG. 1 at reference numeral 10. The apparatus includes two principal elements, a detector 12 for detecting subsurface anomalies, and a projector 14 for projecting a visual representation of the anomaly onto the surface at the location on the surface behind which the subsurface anomaly is present. The detector 12 may be any type of detector that is capable of detecting subsurface conditions, including IR, UV, ultrasonic or subsonic detection. In the embodiment disclosed herein for purposes of illustration, a IR thermal imaging camera is used, such as a FLIR E-25 thermal infrared camera. This camera is a long wave, handheld focal plane array camera capable of temperature measurement. The camera is capable of storing information for later analysis.

The detector 12 is connected by a composite video cable 16 from a “video out” port 18 to the “video in” port 20 of the projector 14. The projector may be any projector capable of receiving video data and converting the data into visual images for projection. For purposes of illustration, a Mitsubishi PK 20 digital light processing (DLP) projector receives the video data input.

The detector 12 and projector 14 are connected by being mounted on a conventional photographic bracket 22. The detector 12 and projector 14 are preferably parallax-corrected to take into account the slightly different positions of the detector lens and projection lens. The Mitsubishi PK 20 will project an adequate color image at from 12-15 from the surface receiving the projected image even in relatively bright ambient light. Other projectors will project a satisfactory image at different distances.

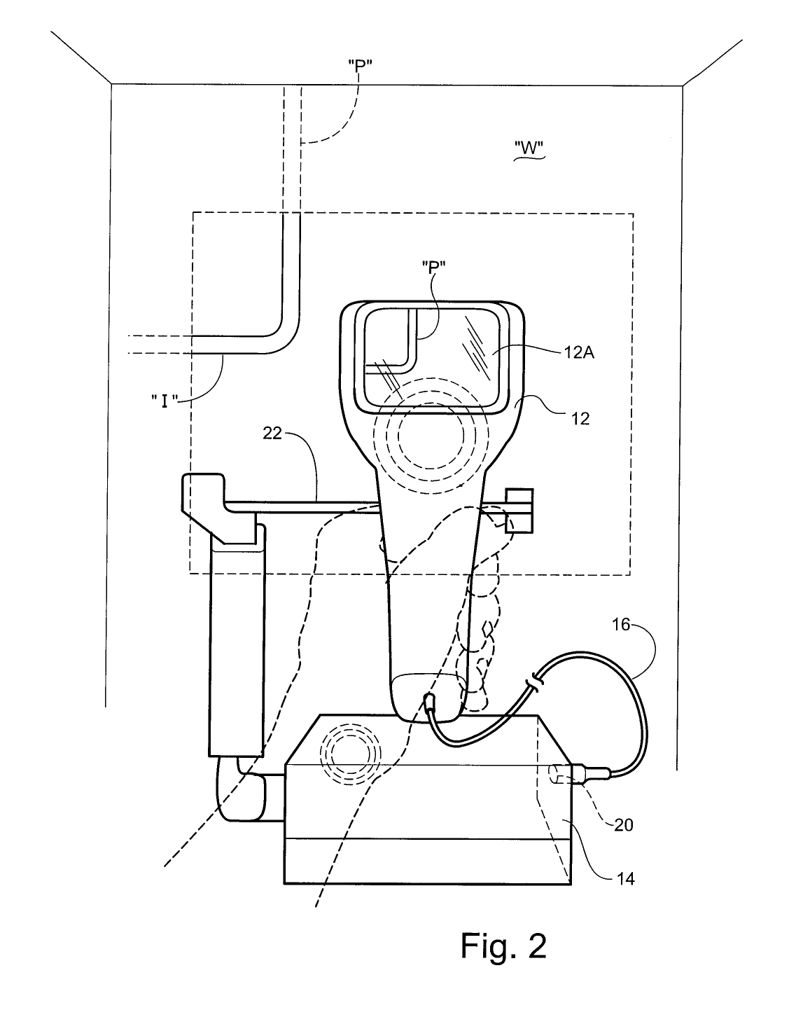

Referring now to FIG. 2, in use, the detector 12, such as the IR thermal imaging camera, is used to detect a subsurface anomaly, such as a temperature variation caused by moisture, lack of insulation, or any other subsurface condition that can be detected. Ordinarily, the detected image would be stored, downloaded at a later time to a computer, analyzed, and put into a report for submission to the customer. However, according to the invention, the image is converted to a digital data signal that is output to the projector 14 in real time.

By way of example, a wall “W” is shown in FIG. 2, and the detector 12 is being used to detect a pipe “P” positioned at some unknown location behind the wall “W”. To locate the pipe, the detector 12 is aimed at the wall “W”, which is scanned until the detector 12 detects the pipe “P”, which can be seen as an IR image on the viewfinder 12A of the detector 12. However, due to the relatively small size and low resolution of the viewfinder 12A, the actual position of the pipe “P” may be difficult to determine, particularly if the wall “W” is large or relatively blank without visual cues.

Because the projector 14 is aligned with the detector 12, a projected image “I” of the pipe “P” is displayed on the wall “W” at the actual location of the pipe “P”. It is therefore possible to mark the wall “W” to indicate the position of the pipe “P”, or even punch through the wall “W” using the projected image “I” as a guide. In this manner, the pipe “P” can be exposed more quickly and with minimal damage to the wall “W”.

As a result, a visual representation of the anomaly can be seen in real time as projected onto the surface behind which the anomaly exists. Features such as the intensity of the temperature variation, the dimensions of the variation and even variations in the intensity or movement of the anomaly during the detection process can be observed. For these reasons, there is a greatly increased utility in the information received from the detection process.

A method and apparatus for detecting subsurface anomalies is described above. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims.

I claim:

1. An apparatus for detecting subsurface anomalies, comprising:
(a) a detector for determining the existence of a subsurface anomaly at a location behind a surface and generating a signal representative of the anomaly; and
(b) a projector mounted in image alignment with the detector for receiving the signal, converting the signal into a visual representation of the anomaly and projecting the visual representation of the anomaly onto the surface at the location on the surface behind which the subsurface anomaly is present.

2. An apparatus according to claim 1, wherein the detector comprises an infrared detector.

3. An apparatus according to claim 1, wherein the detector comprises a thermal infrared camera capable of temperature measurement.

4. An apparatus according to claim 1, wherein the detector comprises a thermal infrared camera capable of temperature measurement, and including a data store for storing digital data representative of temperature measurement.

5. An apparatus according to claim 1, wherein the projector comprises a video projector.

6. An apparatus according to claim 1 wherein the projector comprises a DLP projector.

7. An apparatus according to claim 1, wherein the detector and projector are separate devices connected by a data transfer cable.

8. An apparatus for detecting subsurface anomalies, comprising:
(a) an infrared camera for determining the existence of a subsurface anomaly detectable by the infrared camera at a location behind a surface and generating a signal representative of the anomaly; and
(b) a projector mounted in image alignment with the detector for receiving the signal, converting the signal into a visual representation of the anomaly and projecting the visual representation of the anomaly onto the surface in alignment with the subsurface anomaly.

9. An apparatus according to claim 8, wherein the camera and projector are mounted on a common mounting device.

10. An apparatus according to claim 8, wherein the camera and projector are mounted in vertically spaced-apart relation to each other, and are parallax-corrected for projecting the visual representation of the anomaly at the precise location on the surface behind which the anomaly is present.

11. A method for detecting subsurface anomalies, comprising:
(a) providing a detector for determining the existence of a subsurface anomaly at a location behind a surface;
(b) utilizing the detector to determine the existence of a subsurface anomaly at a location behind the surface;
(c) generating a signal representative of the anomaly;
(d) transmitting the signal to a projector mounted in image alignment with the detector;
(e) converting the signal into a visual representation of the anomaly; and
(f) projecting the visual representation of the anomaly onto the surface at the location on the surface behind which the subsurface anomaly is present.

12. A method according to claim 11, wherein providing a detector comprises providing an infrared detector.

13. A method according to claim 11, wherein providing a detector comprises providing a thermal infrared camera capable of temperature measurement.

14. A method according to claim 11, and including storing digital data representative of temperature measurement.

15. A method according to claim 11 wherein providing the projector comprises providing a video projector.

16. A method according to claim 11, wherein the projector comprises a DLP projector.

17. A method according to claim 11, and including positioning the detector and projector in spaced-apart relation to each other and correcting any parallax between the detector and projector.

18. A method according to claim 11, and including the step of projecting the visual representation of the anomaly onto the surface at the location on the surface behind which the subsurface anomaly is present simultaneously with detecting the anomaly.

19. A method for detecting subsurface anomalies, comprising:
(a) providing a thermal imaging infrared camera for determining the existence of a subsurface thermal anomaly at a location behind a surface;
(b) utilizing the camera to determine the existence of a subsurface thermal anomaly at a location behind the surface;
(c) generating a signal representative of the thermal anomaly;
(d) transmitting the signal to a projector mounted in image alignment with the camera;
(e) converting the signal into a visual representation of the thermal anomaly; and
(f) projecting the visual representation of the anomaly onto the surface at the location on the surface behind which the subsurface anomaly is present simultaneously with the detection of the thermal anomaly by the camera.
